(19) United States
(12) Patent Application Publication
(10) Pub. No.: US 2010/0085292 A1
(43) Pub. Date: Apr. 8, 2010

(54) LIQUID CRYSTAL DISPLAY HAVING DUAL DATA SIGNAL GENERATION MECHANISM

(76) Inventors: Cheng-Hung Chen, Hsin-Chu (TW); Hung-Ju Chang, Hsin-Chu (TW); Meng-Yi Hung, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/401,627

(22) Filed: Mar. 11, 2009

(30) Foreign Application Priority Data
Oct. 6, 2008 (TW) 097138376

(51) Int. Cl. G09G 3/36

(52) U.S. Cl. 345/92; 345/87

(57) ABSTRACT

A liquid crystal display having dual data signal generation mechanism is disclosed for simplifying the display structure and retaining high display quality. The liquid crystal display includes a dual data signal generator, a preliminary data line, a first data line, a second data line, and a pixel unit. The dual data signal generator functions to convert a preliminary data signal, received from the preliminary data line, into a first data signal and a second data signal. The first and second data signals are furnished to the first and second data lines respectively. The pixel unit includes a first sub-pixel unit and a second sub-pixel unit. The first sub-pixel unit is coupled to the first data line for receiving the first data signal. The second sub-pixel unit is coupled to the second data line for receiving the second data signal.

### BACKGROUND OF THE INVENTION

1. Field of the Invention

The present invention relates to a liquid crystal display, and more particularly, to a liquid crystal display having dual data signal generation mechanism.

2. Description of the Prior Art

Because the liquid crystal display (LCD) has advantages of thin appearance, low power consumption, and low radiation, the liquid crystal display has been widely applied in various electronic products such as computer monitors, mobile phones, personal digital assistants (PDAs), or flat panel televisions. In general, the liquid crystal display comprises a liquid crystal layer encapsulated by two substrates. The operation of a liquid crystal display is featured by varying voltage drops between opposite sides of different sections of the liquid crystal layer for twisting the angles of the liquid crystal molecules in different sections of the liquid crystal layer so that the transparency of different sections of the liquid crystal layer can be controlled accordingly for illustrating images.

It is well known that each pixel of a liquid crystal display can be designed to comprise two sub-pixels for achieving a feature of wide viewing angle. That is, based on gray level averaging effect of two gamma curves corresponding to the two sub-pixels, optimal visual experience can be realized in different viewing angles for having a high-quality wide viewing angle.

FIG. 1 is a schematic diagram showing a prior-art liquid crystal display. As shown in FIG. 1, the liquid crystal display 100 comprises a plurality of first data lines 110, a plurality of second data lines 115, a plurality of gate lines 120, a gate driver 130, a first source driver 140, a second source driver 145, a first gamma voltage generator 150, a second gamma voltage generator 155, a plurality of pixel units 180, and a display panel 195. The plurality of first data lines 110 are used for delivering a plurality of first data signals respectively. The plurality of second data lines 115 are used for delivering a plurality of second data signals respectively. Each pixel unit 180 comprises a first sub-pixel unit 181 and a second sub-pixel unit 186. The first sub-pixel unit 181 is coupled to a corresponding first data line 110 for receiving a corresponding first data signal. The second sub-pixel unit 186 is coupled to a corresponding second data line 115 for receiving a corresponding second data signal.

The first gamma voltage generator 150 and the second gamma voltage generator 155 are utilized for generating a plurality of first and second gamma voltages respectively based on two gamma curves. Each first data signal is actually one first gamma voltage selected from the plurality of first gamma voltages, and each second data signal is actually one second gamma voltage selected from the plurality of second gamma voltages. Accordingly, the light outputs of the first and second sub-pixel units 181, 186 in each pixel unit 180 are emitted together to achieve a feature of wide viewing angle based on a gray level averaging effect of two gamma curves. However, the liquid crystal display 100 requires two source drivers and two gamma voltage generators for performing saturation charging processes of the first and second sub-pixel units so as to generate accurate sub-pixel voltages. That is, the liquid crystal display 100 achieves a high-quality image display having wide viewing angle with a pay of complicated structure.

There is another prior-art liquid crystal display having a single source driver and a single gamma voltage generator for achieving a feature of wide viewing angle. However, the prior-art liquid crystal display performs a saturation charging process of only the first sub-pixel unit for generating an accurate sub-pixel voltage, and concurrently performs a non-saturation charging process of the second sub-pixel unit. In the non-saturation charging process, a sub-pixel voltage offset of the second sub-pixel unit caused by the parameter deviation of charging-related devices is likely to occur, which in turn results in a Mura effect and/or an image sticking effect on the display screen. In view of that, the prior-art liquid crystal display having simplified structure is unable to achieve a high-quality image display.

### SUMMARY OF THE INVENTION

In accordance with an embodiment of the present invention, a liquid crystal display having dual data signal generation mechanism is disclosed for achieving a high-quality image display having wide viewing angle with a simplified device structure. The liquid crystal display comprises a preliminary data line, a dual data signal generator, a first data line, a second data line, a gate line, and a pixel unit.

The preliminary data line is used for receiving a preliminary data signal. The dual data signal generator is electrically coupled to the preliminary data line and functions to generate a first data signal and a second data signal based on the preliminary data signal. The first data line is electrically couple to the dual data signal generator for receiving the first data signal. The second data line is electrically couple to the dual data signal generator for receiving the second data signal. The gate line is used for receiving a gate signal. The pixel unit comprises a first sub-pixel unit and a first sub-pixel unit. The first sub-pixel unit is electrically coupled to the first data line for receiving the first data signal. The second sub-pixel unit is electrically coupled to the second data line for receiving the second data signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a prior-art liquid crystal display.

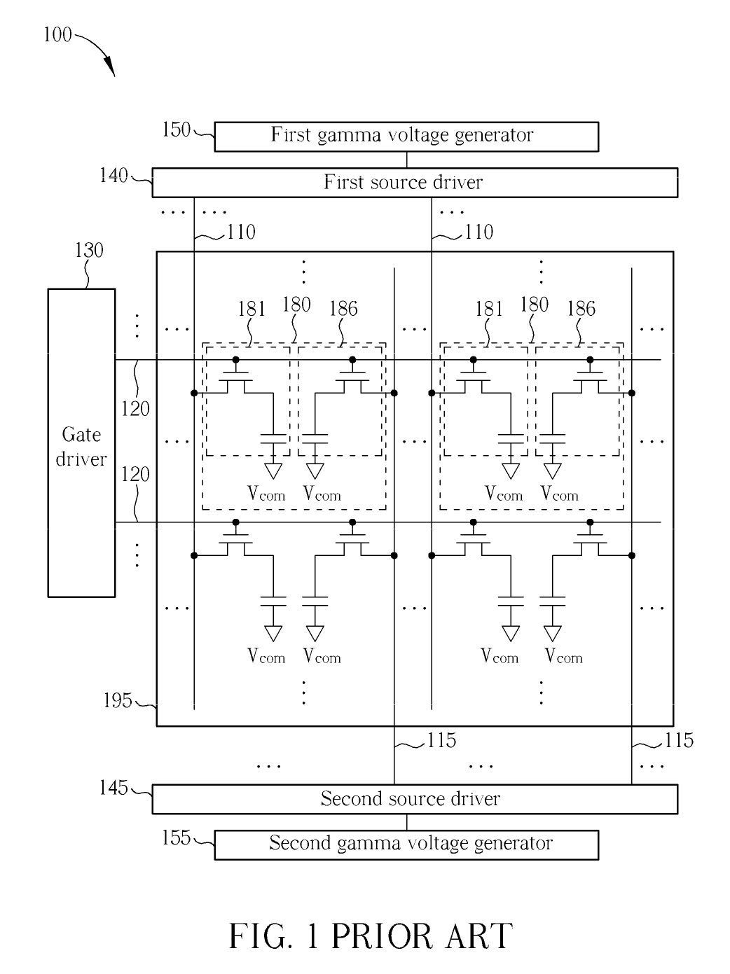

FIG. 2 is a liquid crystal display having dual data signal generation mechanism in accordance with a preferred embodiment of the present invention.

FIG. 3 is a schematic circuit diagram showing a first embodiment of the dual data signal generator shown in FIG. 2.

FIG. 4 is a schematic circuit diagram showing a second embodiment of the dual data signal generator shown in FIG. 2.

FIG. 5 is a schematic circuit diagram showing a third embodiment of the dual data signal generator shown in FIG. 2.

FIG. 6 is a schematic circuit diagram showing a fourth embodiment of the dual data signal generator shown in FIG. 2.

### DETAILED DESCRIPTION

Hereinafter, preferred embodiments of the present invention will be described in detail with reference to the accompanying drawings. Here, it is to be noted that the present invention is not limited thereto.

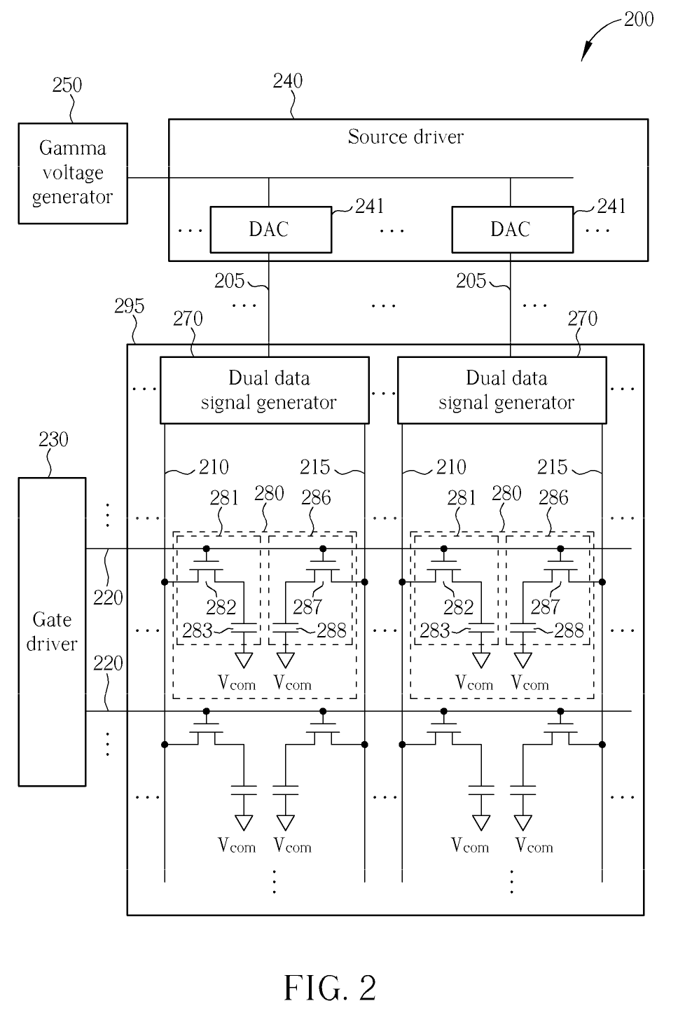

FIG. 2 is a liquid crystal display having dual data signal generation mechanism in accordance with a preferred embodiment of the present invention. As shown in FIG. 2, the liquid crystal display 200 comprises a plurality of preliminary data lines 205, a plurality of first data lines 210, a plurality of second data lines 215, a plurality of gate lines 220, a gate driver 230, a source driver 240, a gamma voltage generator 250, a plurality of pixel units 280, a plurality of dual data signal generators 270, and a display panel 295. The first data lines 210, the second data lines 215, the pixel units 280 and the dual data signal generators 270 are disposed on the display panel 295. Each first pixel unit 280 comprises a first sub-pixel unit 281 and a second sub-pixel unit 286. In another embodiment, the dual data signal generators 270 can be embedded in the source driver 240 instead of being disposed on the display panel 295.

The gate driver 230 is employed to generate a plurality of gate signals. Each gate line 220 is coupled to the gate driver 230 and functions to deliver one corresponding gate signal. The gamma voltage generator 250 is put in use for generating a plurality of gamma voltages. The source driver 240 comprises a plurality of digital-to-analog converters (DACs) 241 for performing signal processing operations on a plurality of digital image signals so as to generate a plurality of preliminary data signals. Each digital-to-analog converter 241 is coupled to the gamma voltage generator 250 and functions to convert a received digital image signal into one corresponding preliminary data signal through performing a selection operation over the plurality of gamma voltages. Each preliminary data line 205 is coupled to the source driver 240 for delivering one corresponding preliminary data signal.

The plurality of first data lines 210 are used to deliver a plurality of first data signals respectively, and the plurality of second data lines 215 are used to deliver a plurality of second data signals respectively. Each dual data signal generator 270 is coupled to one preliminary data line 205 and functions to convert one corresponding preliminary data signal into a corresponding first data signal and a corresponding second data signal. Each first sub-pixel unit 281 is coupled to one corresponding first data line 210 for receiving one corresponding first data signal. Each second sub-pixel unit 286 is coupled to one corresponding second data line 215 for receiving one corresponding second data signal. Each first sub-pixel unit 281 comprises a first switch 282 and a first liquid-crystal capacitor 283. Each second sub-pixel unit 286 comprises a second switch 287 and a second liquid-crystal capacitor 288. The first liquid-crystal capacitor 283 is also termed as a bright capacitor and the second liquid-crystal capacitor 288 is also termed as a dark capacitor. Since the first liquid-crystal capacitor 283 and the second liquid-crystal capacitor 288 are individually charged by the corresponding first data signal and the corresponding second data signal respectively, both the charging processes of the first and second liquid-crystal capacitors 283, 288 can be finished with saturation situations for generating accurate capacitor voltages so as to achieve a high-quality image display.

The first switch 282 comprises a first end coupled to a corresponding first data line 210, a second end coupled to a corresponding first liquid-crystal capacitor 283, and a gate coupled to a corresponding gate line 220 for receiving a corresponding gate signal. The first liquid-crystal capacitor 283 comprises a first end coupled to a corresponding first switch 282 and a second end for receiving a common voltage Vcom. The second switch 287 comprises a first end coupled to a corresponding second data line 215, a second end coupled to a corresponding second liquid-crystal capacitor 288, and a gate coupled to a corresponding gate line 220 for receiving a corresponding gate signal. The second liquid-crystal capacitor 288 comprises a first end coupled to a corresponding second switch 287 and a second end for receiving the common voltage Vcom. The first data signal for charging the first liquid-crystal capacitor 283 is corresponding to a first gamma curve, and the second data signal for charging the second liquid-crystal capacitor 288 is corresponding to a second gamma curve. The first switch 282 and the second switch 287 are thin film transistors or metal oxide semiconductor (MOS) field effect transistors.

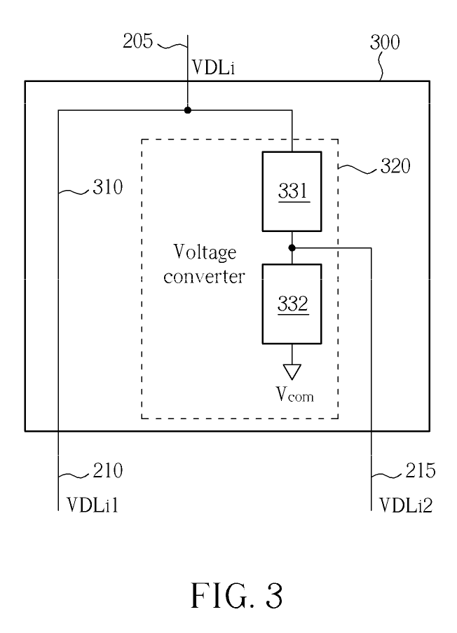

FIG. 3 is a schematic circuit diagram showing a first embodiment of the dual data signal generator shown in FIG. 2. As shown in FIG. 3, the dual data signal generator 300 comprises a transmission line 310 and a voltage converter 320. The transmission line 310, coupled between a corresponding preliminary data line 205 and a corresponding first data line 210, is employed to deliver a preliminary data signal VDLi of the corresponding preliminary data line 205 directly to the corresponding first data line 210. That is, a first data signal VDLi1 received by the corresponding first data line 210 is substantially equal to the preliminary data signal VDLi.

The voltage converter 320 comprises a first resistor 331 and a second resistor 332. The first resistor 331 comprises a first end coupled to the corresponding preliminary data line 205 and a second end coupled to a corresponding second data line 215. The second resistor 332 comprises a first end coupled to the second end of the first resistor 331 and a second end for receiving the common voltage Vcom. In view of the above description, the first data signal VDLi1 corresponding to the first gamma curve is the preliminary data signal VDLi, and the voltage converter 320 is utilized for performing a voltage dividing operation on the preliminary data signal VDLi so as to generate a second data signal VDLi2 corresponding to the second gamma curve. Accordingly, the second data signal VDLi2 divided from the preliminary data signal VDLi can be expressed as Formula (1) listed below:

$$VDLi 2 = \frac{Z 2 * VDLi + Z 1 * Vcom}{Z 1 + Z 2} \qquad Formula ( 1 )$$

Where Z1 represents the resistance of the first resistor 331 and Z2 represents the resistance of the second resistor 332.

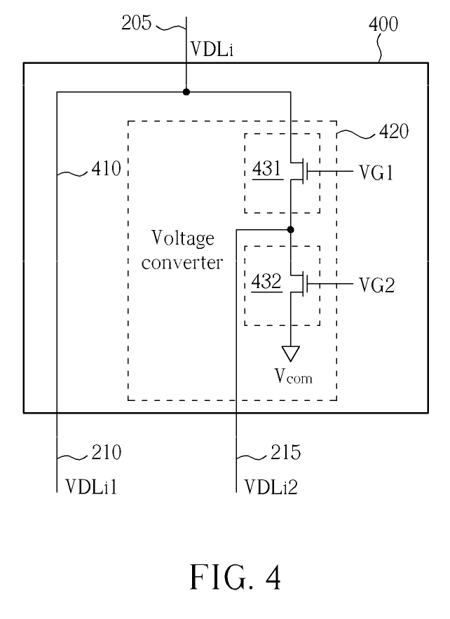

FIG. 4 is a schematic circuit diagram showing a second embodiment of the dual data signal generator shown in FIG. 2. As shown in FIG. 4, the dual data signal generator 400 comprises a transmission line 410 and a voltage converter 420. Similarly, the transmission line 410 is employed to deliver a preliminary data signal VDLi of a corresponding preliminary data line 205 directly to a corresponding first data line 210. That is, a first data signal VDLi1 received by the corresponding first data line 210 is substantially equal to the preliminary data signal VDLi. The voltage converter 420 comprises a first transistor 431 and a second transistor 432. The first transistor 431 comprises a first end coupled to the corresponding preliminary data line 205, a second end coupled to a corresponding second data line 215, and a gate for receiving a first gate signal VG1. The first gate signal VG1 is provided for adjusting the first channel resistance of the first transistor 431. The second transistor 432 comprises a first end coupled to the second end of the first transistor 431, a second end for receiving the common voltage Vcom, and a gate for receiving a second gate signal VG2. The second gate signal VG2 is provided for adjusting the second channel resistance of the second transistor 432. The first transistor 431 and the second transistor 432 are thin film transistors or MOS field effect transistors.

The voltage converter 420 may function as an adjustable voltage divider for generating a second data signal VDLi2 by dividing the preliminary data signal VDLi based on the adjusted first and second channel resistances. That is, the voltage converter 420 is capable of converting the preliminary data signal VDLi into the second data signal VDLi2 corresponding to the second gamma curve based on the first gate signal VG1 and the second gate signal VG2. In another embodiment, both the gates of the first transistor 431 and the second transistor 432 receive same gate signal, the first channel resistance is determined by the channel width/length ratio of the first transistor 431, and the second channel resistance is determined by the channel width/length ratio of the second transistor 432. In other words, the voltage dividing ratio of the voltage converter 420 is determined based on the channel width/length ratios of the first transistor 431 and the second transistor 432. The channel width/length ratios of the first transistor 431 and the second transistor 432 can be identical or different.

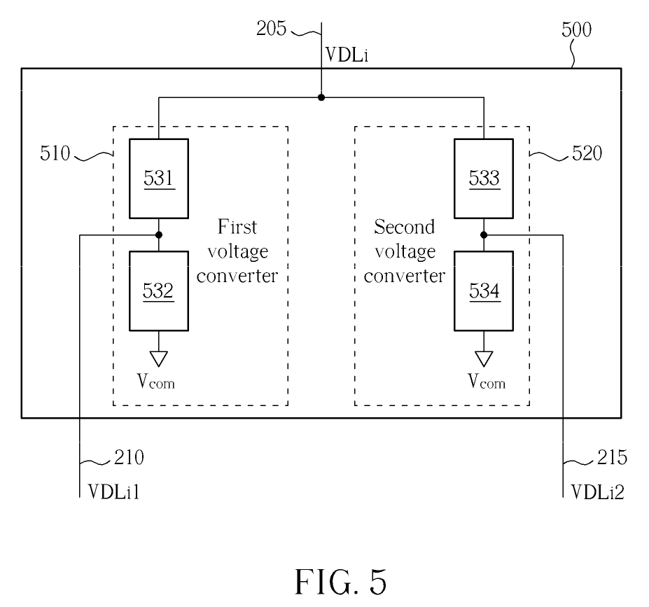

FIG. 5 is a schematic circuit diagram showing a third embodiment of the dual data signal generator shown in FIG. 2. As shown in FIG. 5, the dual data signal generator 500 comprises a first voltage converter 510 and a second voltage converter 520. The first voltage converter 510 comprises a first resistor 531 and a second resistor 532. The first resistor 531 comprises a first end coupled to a corresponding preliminary data line 205 and a second end coupled to a corresponding first data line 210. The second resistor 532 comprises a first end coupled to the second end of the first resistor 531 and a second end for receiving the common voltage Vcom. In view of that, the first voltage converter 510 is utilized for performing a voltage dividing operation on the preliminary data signal VDLi so as to generate a first data signal VDLi1 corresponding to the first gamma curve. Accordingly, the first data signal VDLi1 divided from the preliminary data signal VDLi can be expressed as Formula (2) listed below:

$$VDLi 1 = \frac{Z 2 * VDLi + Z 1 * Vcom}{Z 1 + Z 2} \qquad Formula ( 2 )$$

Where Z1 represents the resistance of the first resistor 531 and Z2 represents the resistance of the second resistor 532.

The second voltage converter 520 comprises a third resistor 533 and a fourth resistor 534. The third resistor 533 comprises a first end coupled to the corresponding preliminary data line 205 and a second end coupled to a corresponding second data line 215. The fourth resistor 534 comprises a first end coupled to the second end of the third resistor 533 and a second end for receiving the common voltage Vcom. In view of that, the second voltage converter 520 is utilized for performing a voltage dividing operation on the preliminary data signal VDLi so as to generate a second data signal VDLi2 corresponding to the second gamma curve. Accordingly, the second data signal VDLi2 divided from the preliminary data signal VDLi can be expressed as Formula (3) listed below:

$$VDLi 2 = \frac{Z 4 * VDLi + Z 3 * Vcom}{Z 3 + Z 4} \qquad Formula ( 3 )$$

Where Z3 represents the resistance of the third resistor 533 and Z4 represents the resistance of the fourth resistor 534.

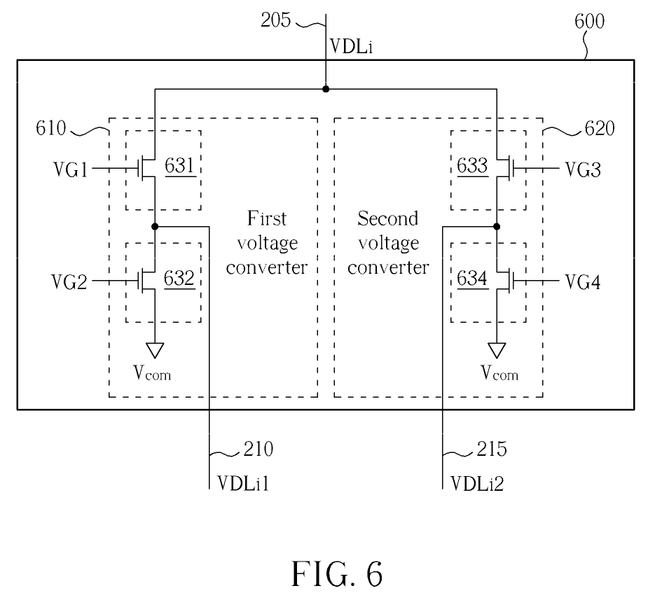

FIG. 6 is a schematic circuit diagram showing a fourth embodiment of the dual data signal generator shown in FIG. 2. As shown in FIG. 6, the dual data signal generator 600 comprises a first voltage converter 610 and a second voltage converter 620. The first voltage converter 610 comprises a first transistor 631 and a second transistor 632. The first transistor 631 comprises a first end coupled to a corresponding preliminary data line 205, a second end coupled to a corresponding first data line 210, and a gate for receiving a first gate signal VG1. The first gate signal VG1 is provided for adjusting the first channel resistance of the first transistor 631. The second transistor 632 comprises a first end coupled to the second end of the first transistor 631, a second end for receiving the common voltage Vcom, and a gate for receiving a second gate signal VG2. The second gate signal VG2 is provided for adjusting the second channel resistance of the second transistor 632. The first transistor 631 and the second transistor 632 are thin film transistors or MOS field effect transistors.

The second voltage converter 620 comprises a third transistor 633 and a fourth transistor 634. The third transistor 633 comprises a first end coupled to the corresponding preliminary data line 205, a second end coupled to a corresponding second data line 215, and a gate for receiving a third gate signal VG3. The third gate signal VG3 is provided for adjusting the third channel resistance of the third transistor 633. The fourth transistor 634 comprises a first end coupled to the second end of the third transistor 633, a second end for receiving the common voltage Vcom, and a gate for receiving a fourth gate signal VG4. The fourth gate signal VG4 is provided for adjusting the fourth channel resistance of the fourth transistor 634. The third transistor 633 and the fourth transistor 634 are thin film transistors or MOS field effect transistors.

Both the first voltage converter 610 and the second voltage converter 620 may function as adjustable voltage dividers. The first voltage converter 610 is used to generate a first data signal VDLi1 by dividing the preliminary data signal VDLi based on the adjusted first and second channel resistances. That is, the first voltage converter 610 is capable of converting the preliminary data signal VDLi into the first data signal VDLi1 corresponding to the first gamma curve based on the first gate signal VG1 and the second gate signal VG2. The second voltage converter 620 is used to generate a second data signal VDLi2 by dividing the preliminary data signal VDLi based on the adjusted third and fourth channel resistances. That is, the second voltage converter 620 is capable of converting the preliminary data signal VDLi into the second data signal VDLi2 corresponding to the second gamma curve based on the third gate signal VG3 and the fourth gate signal VG4.

In another embodiment, all the gates of the first transistor 631 through the fourth transistor 634 receive same gate signal, the first channel resistance is determined by the channel width/length ratio of the first transistor 631, the second channel resistance is determined by the channel width/length ratio of the second transistor 632, the third channel resistance is determined by the channel width/length ratio of the third transistor 633, and the fourth channel resistance is determined by the channel width/length ratio of the fourth transistor 634. In other words, the voltage dividing ratio of the first voltage converter 610 is determined based on the channel width/length ratios of the first transistor 631 and the second transistor 632, and the voltage dividing ratio of the second voltage converter 620 is determined based on the channel width/length ratios of the third transistor 633 and the fourth transistor 634. The channel width/length ratios of the first transistor 631 and the second transistor 632 can be identical or different. Also, the channel width/length ratios of the third transistor 633 and the fourth transistor 634 can be identical or different.

In summary, by making use of dual data signal generation mechanism, the liquid crystal display of the present invention requires only a single source driver and a single gamma voltage generator. Furthermore, both the charging processes of the first and second sub-pixel units are finished with saturation situations so as to generate accurate sub-pixel voltages. For that reason, the liquid crystal display of the present invention is able to achieve a high-quality image display having wide viewing angle regardless of the simplified device structure.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A liquid crystal display comprising:
a preliminary data line for receiving a preliminary data signal;
a dual data signal generator, electrically coupled to the preliminary data line, for generating a first data signal and a second data signal based on the preliminary data signal;
a first data line electrically couple to the dual data signal generator for receiving the first data signal;
a second data line electrically couple to the dual data signal generator for receiving the second data signal;
a gate line for receiving a gate signal; and
a pixel unit comprising:
a first sub-pixel unit electrically coupled to the first data line for receiving the first data signal; and
a second sub-pixel unit electrically coupled to the second data line for receiving the second data signal.

2. The liquid crystal display of claim 1, wherein the dual data signal generator comprises:
a voltage converter, electrically coupled between the preliminary data line and the second data line, for converting the preliminary data signal into the second data signal; and
a transmission line electrically coupled between the preliminary data line and the first data line.

3. The liquid crystal display of claim 2, wherein the voltage converter comprises:
a first resistor comprising a first end electrically coupled to the preliminary data line and a second end electrically coupled to the second data line; and
a second resistor comprising a first end electrically coupled to the second end of the first resistor and a second end for receiving a common voltage.

4. The liquid crystal display of claim 2, wherein the voltage converter comprises:
a first transistor comprising a first end electrically coupled to the preliminary data line, a second end electrically coupled to the second data line, and a gate for receiving a first gate signal; and
a second transistor comprising a first end electrically coupled to the second end of the first transistor, a second end for receiving a common voltage, and a gate for receiving a second gate signal.

5. The liquid crystal display of claim 4, wherein the first transistor and the second transistor are thin film transistors or metal oxide semiconductor (MOS) field effect transistors.

6. The liquid crystal display of claim 1, wherein the dual data signal generator comprises:
a first voltage converter, electrically coupled between the preliminary data line and the first data line, for converting the preliminary data signal into the first data signal; and
a second voltage converter, electrically coupled between the preliminary data line and the second data line, for converting the preliminary data signal into the second data signal.

7. The liquid crystal display of claim 6, wherein the first voltage converter comprises:
a first resistor comprising a first end electrically coupled to the preliminary data line and a second end electrically coupled to the first data line; and
a second resistor comprising a first end electrically coupled to the second end of the first resistor and a second end for receiving a common voltage.

8. The liquid crystal display of claim 6, wherein the first voltage converter comprises:
a first transistor comprising a first end electrically coupled to the preliminary data line, a second end electrically coupled to the first data line, and a gate for receiving a first gate signal; and
a second transistor comprising a first end electrically coupled to the second end of the first transistor, a second end for receiving a common voltage, and a gate for receiving a second gate signal.

9. The liquid crystal display of claim 8, wherein the first transistor and the second transistor are thin film transistors or MOS field effect transistors.

10. The liquid crystal display of claim 6, wherein the second voltage converter comprises:
a first resistor comprising a first end electrically coupled to the preliminary data line and a second end electrically coupled to the second data line; and
a second resistor comprising a first end electrically coupled to the second end of the first resistor and a second end for receiving a common voltage.

11. The liquid crystal display of claim 6, wherein the second voltage converter comprises:
a first transistor comprising a first end electrically coupled to the preliminary data line, a second end electrically coupled to the second data line, and a gate for receiving a first gate signal; and
a second transistor comprising a first end electrically coupled to the second end of the first transistor, a second end for receiving a common voltage, and a gate for receiving a second gate signal.

12. The liquid crystal display of claim 11, wherein the first transistor and the second transistor are thin film transistors or MOS field effect transistors.

13. The liquid crystal display of claim 1, wherein:
the first sub-pixel unit comprises:
a first switch comprising a first end electrically coupled to the first data line for receiving the first data signal, a gate electrically coupled to the gate line for receiving the gate signal, and a second end; and
a first liquid-crystal capacitor comprising a first end electrically coupled to the second end of the first switch and a second end for receiving a common voltage; and
the second sub-pixel unit comprises:
a second switch comprising a first end electrically coupled to the second data line for receiving the second data signal, a gate electrically coupled to the gate line for receiving the gate signal, and a second end; and
a second liquid-crystal capacitor comprising a first end electrically coupled to the second end of the second switch and a second end for receiving the common voltage.

14. The liquid crystal display of claim 13, wherein the first switch and the second switch are thin film transistors or MOS field effect transistors.

15. The liquid crystal display of claim 1, further comprising:
a source driver, electrically coupled to the preliminary data line, for providing the preliminary data signal; and
a gate driver, electrically coupled to the gate line, for providing the gate signal.

16. The liquid crystal display of claim 15, wherein the source driver comprises:
a digital-to-analog converter, electrically coupled to the preliminary data line, for performing a digital-to-analog operation on a digital image signal so as to generate the preliminary data signal.

17. The liquid crystal display of claim 16, further comprising:
a gamma voltage generator, electrically coupled to the digital-to-analog converter of the source driver, for providing a plurality of gamma voltages to the digital-to-analog converter;
wherein the digital-to-analog converter generates the preliminary data signal through performing the digital-to-analog operation on the digital image signal according to the plurality of gamma voltages.
